(19) United States
(12) Patent Application Publication
(10) Pub. No.: US 2016/0028324 A1
(43) Pub. Date: Jan. 28, 2016

(54) POWER-OVER-ETHERNET POWERED INVERTER

(71) Applicant: Ant Lamp Corp., Vancouver, WA (US)

(72) Inventor: Sultan WEATHERSPOON, Vancouver, WA (US)

(21) Appl. No.: 14/337,830

(22) Filed: Jul. 22, 2014

(51) Int. Cl. H02M 7/5381; H04L 12/10; H02M 7/483

(52) U.S. Cl. CPC H02M 7/5381; H02M 7/483; H04L 12/10; H02M 2001/0006

(57) ABSTRACT

An apparatus may include a data management assembly and a DC to AC inverter assembly. The data management assembly may include a data input, a data output, and a power port. The data management assembly may be configured to receive in combination a data signal and a variable DC input voltage on the data input, separate the received data signal from the input voltage, output the data signal on the data output, and output the input voltage on the power port. The DC to AC inverter assembly may be configured to receive the input voltage from the power port, boost the input voltage to a predetermined DC stepped-up voltage that is constant for different input voltages, convert the stepped-up voltage to an AC voltage, and output the AC voltage on a power output.

### BACKGROUND

Power over Ethernet (PoE) systems are generally configured to transmit electrical power along with data on Ethernet cabling. This allows a single cable to provide both data and electrical power. The power may be applied to an Ethernet cable by a power source equipment (PSE) device for use by a powered device (PD). Examples of PDs may include wireless network access points, routers, IP cameras, or other such devices. Power may be carried on the same Ethernet conductors as the data, or it may be carried on dedicated conductors in the same Ethernet cable.

There are several common techniques for transmitting power over Ethernet cabling. A first technique involves utilizing a subset of conductors in an Ethernet cable for data transmission (e.g., 10BASE-T or 10BASE-TX data transmission), and the other conductors of the Ethernet cable for power transmission. In a second technique, power may be transmitted on the data conductors of the Ethernet cable by applying a common-mode voltage to each pair of these conductors. Because Ethernet uses differential signaling, this technique of applying a common-mode voltage does not interfere with data transmission.

However, such PoE transmitted power is typically characterized by a direct current (DC) voltage substantially below 60V. Accordingly, PDs are generally configured to include power inputs for receiving such a voltage.

### BRIEF SUMMARY OF THE DISCLOSURE

Embodiments disclosed herein may be configured to boost and then invert DC voltage received from a PSE device to produce a standard AC voltage output (e.g., 120 VAC or 240 VAC), thus enabling a PoE cable to power an external device via a standard AC voltage input.

In one example, an apparatus may include a data management assembly and a DC to AC inverter assembly. The data management assembly may include a data input, a data output, and a power port. The data management assembly may be configured to receive in combination a data signal and a variable DC input voltage on the data input, to separate the received data signal from the input voltage, to output the data signal on the data output, and to output the input voltage on the power port. The DC to AC inverter assembly may be configured to receive the input voltage from the power port, to boost the input voltage to a predetermined DC stepped-up voltage that is constant for different input voltages, to convert the stepped-up voltage to an AC voltage, and to output the AC voltage on a power output.

In another example, an apparatus may include a data management assembly, a boost converter, a controller circuit, an inductor assembly, first and second switches, a driver assembly, and an opto-coupler. The data management assembly may include a data input, a data output, and a power port. The data management assembly may be configured to receive in combination a data signal and a variable DC input voltage on the data input, to separate the data signal and the input voltage, to output the data signal on the data output, and to output the separated input voltage on the power port. The boost converter may be configured to receive the input voltage on the power port, and to boost the input voltage to a DC stepped-up voltage determined by a voltage-control signal. The controller circuit may be configured to receive an input voltage signal representative of the received input voltage, and to generate the voltage-control signal appropriate to cause the boost converter to boost the input voltage to a predetermined stepped-up voltage that is constant for different input voltages. The inductor assembly may be configured to receive the predetermined stepped-up voltage from the boost converter, and to produce therefrom positive and negative stepped-up voltages. The first and second switches may be configured to apply the respective positive and negative stepped-up voltages from the inductor assembly to a first output node, in response to received switch drive signals. The driver assembly may be electrically connected to the first and second switches. The driver assembly may produce the switch drive signals in response to received switch control signals. The opto-coupler may convey the switch control signals output by the controller circuit to the driver assembly, and may electrically isolate the controller circuit from the driver assembly. The controller circuit may be configured to generate switch control signals to operate the first and second switches via the opto-coupler and the driver assembly to alternatingly apply the positive and negative stepped-up voltages on the first output node to produce an AC voltage output between the first output node and a second output node.

### BRIEF DESCRIPTION OF THE DRAWINGS

FIG. 1 is a schematic block diagram of a system including a source device, an external device, and an apparatus having a data management assembly and a DC to AC inverter assembly.

FIG. 2 is a schematic block diagram depicting an embodiment of the inverter assembly of FIG. 1.

FIG. 3 is a schematic timeline depicting a first mode of operation of the inverter assembly of FIG. 2 in which exemplary positive and negative stepped-up voltages produced by the inverter assembly are alternatingly applied to a first output node of the inverter assembly to produce an AC voltage between the first output node and a second output node of the inverter assembly.

FIG. 4 is a schematic timeline depicting a second mode of operation of the inverter assembly of FIG. 2 in which the inverter assembly produces an AC voltage by alternatingly outputting a combination of the positive stepped-up voltage on the first output node and the negative stepped up voltage on the second output node, and a combination of the negative stepped-up voltage on the first input node and the positive stepped-up voltage on the second output node.

### DETAILED DESCRIPTION

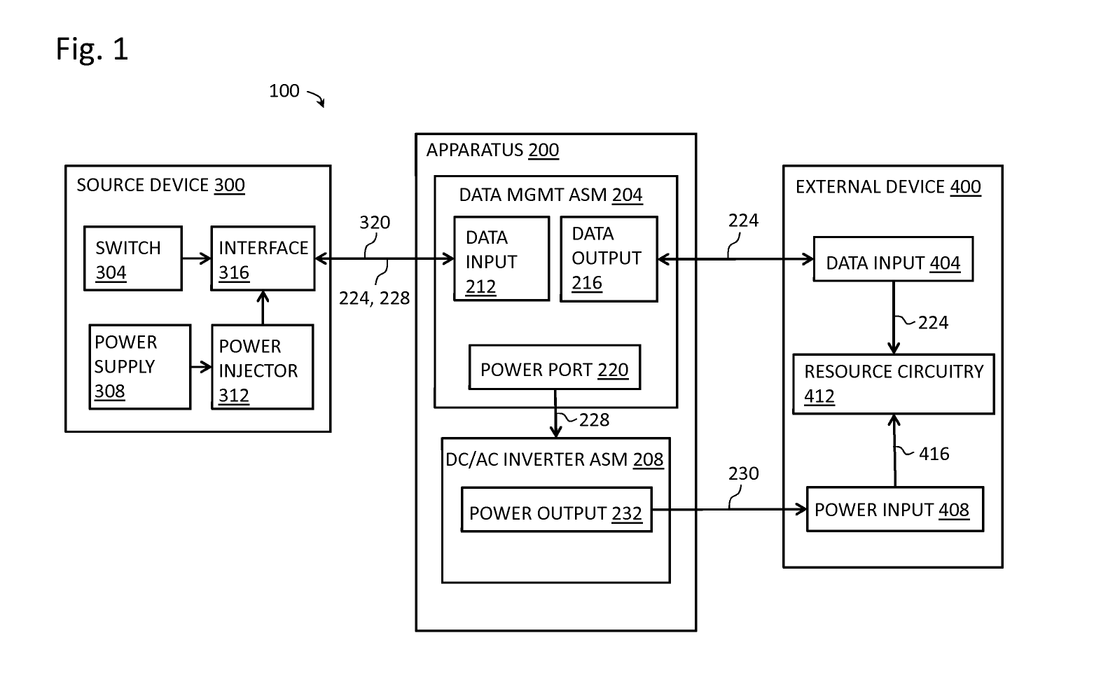

FIG. 1 depicts a system 100 including an apparatus 200. Apparatus 200 may include a data management assembly 204 and a DC to AC inverter assembly 208. Assembly 204 may include a data input 212, a data output 216, and a power port 220. Assembly 204 may be configured to receive in combination a data signal 224 and a variable DC input voltage 228 (e.g., 32 VDC to 56 VDC) on data input 212, to separate the received data signal from the input voltage, to output data signal 224 on data output 216, and to output input voltage 228 on power port 220. Assembly 208 may be configured to receive input voltage 228 from power port 220, and to boost input voltage 228 to a predetermined DC stepped-up voltage that is constant for different input voltages, and to convert the stepped-up voltage to an AC voltage 230, and to output AC voltage 230 on a power output 232, which may be included in apparatus 200, such as in assembly 208.

In some embodiments, system 100 may include a source device 300 from which data input 212 may receive in combination data signal 224 and variable DC input voltage 228. For example, device 300 may be a PSE device similar to that described in U.S. Pat. No. 8,386,088, which is hereby incorporated by reference. In particular, device 300 may include a switch 304 (e.g., an Ethernet switch, a USB switch, or other switch configured to produce a data signal), a power supply 308, a power injector 312, and an interface 316. Switch 304, power supply 308, and power injector 312 may be coupled to interface 316 to inject power and data onto wires of a network cable 320 (e.g., a twisted pair CAT5e Ethernet cable, a USB cable, or other cable or medium suitable for transmission of data and power), which may connect interface 316 to data input 212. More specifically, switch 304 may be configured to supply data signal 224 (e.g., an Ethernet data signal, a USB signal, or other suitable data signal) to interface 316.

Power supply 308 may be configured to supply a DC voltage output to interface 316 via power injector 312. Interface 316 may be configured to output the supplied data signal and DC voltage output on network cable 320.

System 100 may utilize active PoE. For example, apparatus 200 (e.g., assembly 204) and/or device 300 may include circuitry for modulating power and data for transmission over cable 320 to apparatus 200. In particular, the circuitry may include one or more components and/or functionalities, such as those described in U.S. Pat. No. 8,386,088, which may enable system 100 to detect when apparatus 200 is connected to cable 320, determine (or detect) whether a configuration of apparatus 200 is suitable for receiving power from device 300, and/or determine how much power to transmit over cable 320 based on the configuration of apparatus 200. While device 300 may be configured to output a substantially constant and/or predetermined DC voltage output (e.g., 56 VDC) on cable 320, varying cable lengths and loads, among other factors, may result in the DC voltage received by apparatus 200 being a substantially variable DC voltage, such as voltage 228, which may vary in a range of about 32 VDC to about 56 VDC when received at input 212.

As shown in FIG. 1, system 100 may further include an external device 400. Device 400 may include a data input 404, a power input 408, and resource circuitry 412. Data input 404 may be configured to receive data signal 224 from device 300 (e.g., via apparatus 200), and to supply data signal 224 to circuitry 412 via a second data cable. Circuitry 412 may be configured to receive, store, and/or process data signal 224 from data input 404. For example, circuitry 412 may include display circuitry (e.g., if device 400 is or includes a television or other display), data storage circuitry, and/or data processing circuitry. However, circuitry 412 may not be configured to receive power (much less a variable level of power) via data input 404, and in some cases may even be damaged by reception of such power via data input 404. For example, external device 400 may be configured to receive a standard AC voltage input (e.g., 120 VAC or 240 VAC) via power input 408, convert that standard AC voltage input to a particular DC voltage 416, and power circuitry 412 with DC voltage 416 (e.g., by supplying DC voltage 416 to circuitry 412). In some examples resource circuitry 412 may use the received AC voltage directly.

Accordingly, apparatus 200 may be (or be included in) an adapter that enables device 400 to receive both data and power from device 300. In particular, assembly 204 may be configured to pass the data signal from device 300 to device 400, and assembly 208 in conjunction with assembly 204 may be configured to receive power for device 300, to boost and invert that power (as described above) to a suitable AC voltage level for powering device 400 via input 408.

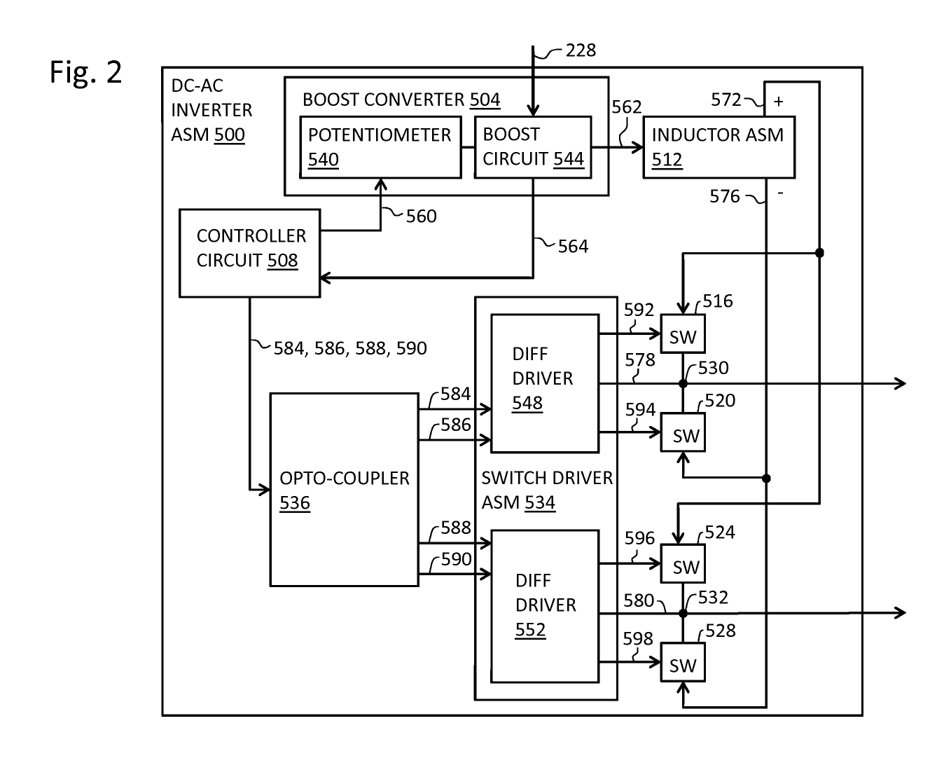

FIG. 2 depicts a DC to AC inverter assembly 500, which is an example of assembly 208. Assembly 500 may include a boost converter 504, a controller circuit 508, an inductor assembly 512, a first switch 516, a second switch 520, a third switch 524, a fourth switch 528, a first output node 530, a second output node 532, a switch driver assembly 534, and an opto-coupler 536. As shown, boost converter 504 includes a potentiometer 540 and a boost circuit 544, and driver assembly 534 includes first and second differential drivers 548, 552. Opto-coupler 536 may be electrically connected between controller circuit 508 and switch driver assembly 534, and may electrically isolate controller circuit 508 from the high voltages in the circuits of assembly 534 and switches 516, 520, 524, and 528. Outputs of respective switches 516, 520 may be electrically connected to node 530. Similarly, outputs of respective switches 524, 528 may be electrically connected to node 532. Nodes 530, 532 may be electrically connected to power output 232 (see FIG. 1).

Examples of suitable switches include field-effect transistors (FETs), and in particular metal-oxide-semiconductor FETs (MOSFETs). An example of a suitable opto-coupler is a multi-channel and bi-directional 15 MBd digital logic gate opto-coupler (e.g., model number ACSL-6400-50TE) available from Avago Technologies of San Jose, Calif., U.S.A. An example of a suitable differential driver is a high-voltage high/low-side driver (e.g., model number L6390DTR) available through STMicroelectronics of Geneva, Switzerland. An example of a suitable power switch is an OPTIMOS™ 3 power-transistor (e.g., model number BSC900N2ONS3 G) available from Infineon Technologies AG of Neubiberg, Germany. An example of a suitable potentiometer is a digital rheostat model number AD5272 or AD5274) available from Analog Devices, Inc. of Norwood, Mass., U.S.A. An example of a suitable boost circuit is model number LT3758A available from Linear Technology Corporation of Milpitas, Calif.

Boost converter 504 may be configured to receive input voltage 228 (e.g., from power port 220), and to step input voltage 228 up to a DC stepped-up voltage, which may be determined by a voltage-control signal 560. Signal 560 may be appropriate to cause boost converter 504 to boost input voltage 228 to a predetermined DC stepped-up voltage 562 (e.g., 120 VDC, or in some embodiments 60 VDC) that may be constant for different input voltages. For example, controller circuit 508 may be configured to receive an input-voltage signal 564 (e.g., from and/or produced by boost circuit 544). Signal 564 may be representative of input voltage 228 received by boost converter 504. Controller circuit 508 may be responsive to signal 564 to produce (or generate) signal 560, and to transmit signal 560 to potentiometer 540. Potentiometer 540 may be configured to produce a resistance based on received signal 560, and booster circuit 544 may be connected to potentiometer 540 for stepping up input voltage 228 (to stepped-up voltage 562) based on the produced resistance of potentiometer 540. Inductor assembly 512 may be configured to receive stepped-up voltage 562 from boost converter 504 (e.g., from boost circuit 544) and to produce therefrom a positive stepped-up voltage 572 (e.g., +120 VDC, or in some cases +60V DC) and a negative stepped-up voltage 576 (e.g., −120 VDC, or in some cases −60V DC). In some embodiments, voltage 572 may be within 10 percent of +120 VDC, and voltage 576 may be within 10 percent of −120 VDC. For example, though not shown, inductor assembly 512 may include mutually coupled inductors, with one inductor configured to provide a positive output voltage and another inductor configured to provide a negative output voltage. Energy output from the inductors may be stored on a capacitor assembly disposed between each respective output and a circuit ground reference. Other conventional circuits may also be used to produce the positive and negative stepped-up voltages.

Switches 516, 520 may be configured to receive a respective one of voltages 572, 576, and to selectively apply a first voltage output to node 530. Similarly, switches 524, 528 may be configured to receive a respective one of voltages 572, 576, and to selectively apply a second voltage output to node 532. In particular, switches 516, 524 may receive voltage 572, and may selectively apply voltage 572 on respective nodes 530, 532. Similarly, switches 520, 528 may receive voltage 576, and may selectively apply voltage 576 on respective nodes 530, 532.

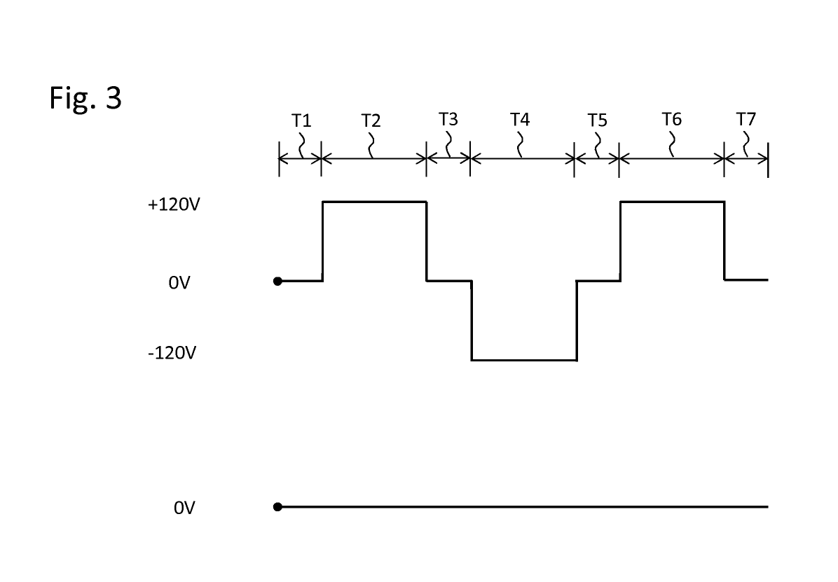

Controller circuit 508 may be configured to operate switches 516, 520 (e.g., via opto-coupler 536 and driver 548) to alternatingly output voltages 572, 576 to node 530 to produce a first AC output voltage relative to output node 532, such as a first AC voltage output between nodes 530, 532 (e.g., as depicted in FIG. 3, which is described further below in more detail). When node 532 is maintained at a reference voltage, such as circuit ground, then the AC output voltage is determined by the voltage on node 530.

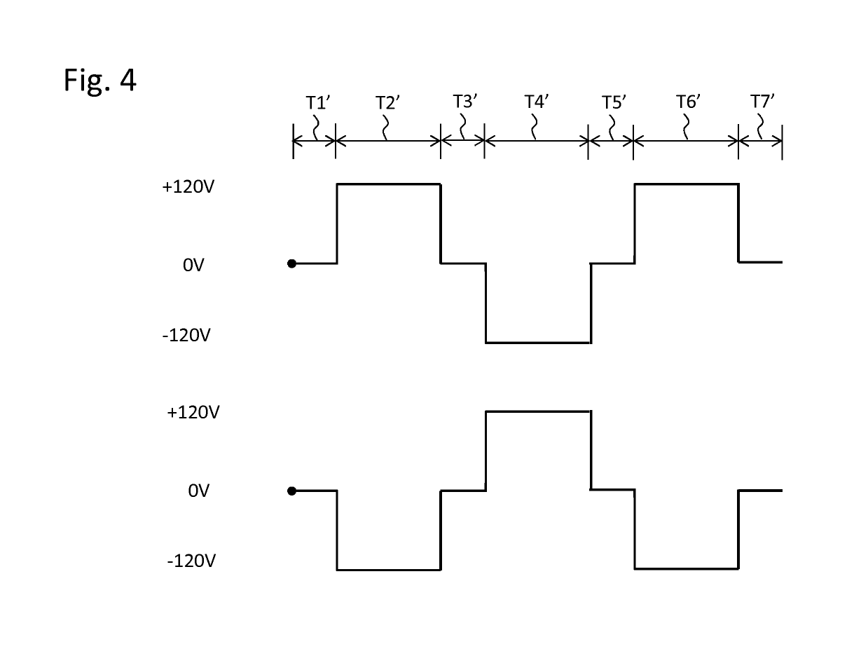

In some embodiments, controller circuit 508 may be configured to operate switches 524, 528 (e.g., via opto-coupler 536 and driver 548) in combination with switches 516, 520 (via opto-coupler 536 and driver 552) to produce the AC voltage output (e.g., a second AC voltage output) by alternatingly outputting a combination of voltage 572 on node 530 and voltage 576 on node 532, and a combination of voltage 576 on node 530 and voltage 572 on node 532 (e.g., as depicted in FIG. 4, which is also described further below in more detail).

For example, controller circuit 508 may be configured to generate and output one or more switch control signals, such as switch control signals 584, 586, 588, and/or 590. Opto-coupler 536 may be configured to communicate one or more of signals 584, 586, 588, 590 to switch-driver assembly 534. For example, opto-coupler 536 may be configured to convey signals 584, 586 to driver 548, and/or may be configured to convey signals 588, 590 to driver 552. Driver 548 may be electrically connected to switches 516, 520, and may be configured to produce switch drive signals 592, 594 in response to received signals 584, 586. In particular, driver 548 may be configured to produce signal 592 in response to received signal 584, and to produce signal 594 in response to received signal 586. Similarly, driver 552 may be electrically connected to switches 524, 528, and may be configured to produce switch drive signals 596, 598 in response to received signals 588, 590. In particular, driver 552 may be configured to produce signal 596 in response to received signal 588, and to produce signal 598 in response to received signal 590. Switches 516, 520 may be configured to apply respective voltages 572, 576 to node 530 in response to respective signals 592, 594. Similarly, switches 524, 528 may be configured to apply respective voltages 572, 576 to node 532 in response to respective signals 596, 598.

While signals 584, 586 may be on separate channels (e.g., each of signals 584, 586 may include generated high and low signals carried over separate conductors), in other embodiments these signals may be on the same channel. For example, signals 584, 586 may be respective high and low signals transmitted over the same conductor. Similarly, signals 588, 590 may be on the same or separate channels. If signals 584, 586 (and/or signals 588, 590) are on the same channel, then, for example, the associated switches may be configured to operate in the off state in the absence of a corresponding switch drive signal, or the associated driver may be configured to generate a switch drive signal corresponding (or for operation) to the off state in the absence of a corresponding switch control signal.

FIG. 3 depicts a schematic timeline of exemplary voltage levels on nodes 530, 532 in consecutive time durations T1-T7 when producing the first AC voltage, with an alternating voltage level on node 530 shown in an upper portion of FIG. 3, and a constant zero or ground voltage level on node 532 shown in a lower portion of FIG. 3. In some embodiments, signals 588, 590 may be configured to operate both of switches 524, 528 in an off state to prevent either of voltages 572, 576 from being applied to node 532 when producing the first AC voltage. In other embodiments, node 532 may simply be a circuit ground and driver 552 and switches 524, 528 may not be included in inverter assembly 500, in which case the apparatus may be configured to only output the first AC voltage.

As can be inferred from the upper portion of FIG. 3, controller circuit 508 may be configured to operate both of switches 516, 520 in the off state (e.g., during durations T1, T3, T5, T7) prior to operating either one of switches 516, 520 in an on state (e.g., during durations T2, T4, T6, etc.). This may provide the apparatus with an increased level of operational safety, such as avoiding having switches 516, 520 both on at the same time, and/or may produce an AC voltage output that better approximates a sinusoidal waveform, as shown. On this second point, the voltages shown in FIGS. 3 and 4 are idealized, and illustrate the operating states of the switches. The associated circuits do not respond instantly, resulting in smoothing of the waveforms shown.

In particular, during durations T1, T3, T5, T7, corresponding signals 584, 592 may be configured to operate switch 516 in the off state to prevent the positive stepped-up voltage from being applied to node 530 when switch 520 is in the on state. Similarly, signal 586 may be configured to operate switch 520 in the off state to prevent the negative stepped-up voltage from being applied to node 530 when switch 516 is in the on state. During durations T2, T6, corresponding signals 584, 592 may be configured to operate switch 516 in the on state to apply the positive stepped-up voltage to node 530, and corresponding signals 586, 594 may be configured to operate switch 520 in the off state to prevent the negative stepped-up voltage from being applied to node 530. Similarly, during duration T4 and subsequent corresponding periods, corresponding signals 584, 592 may be configured to operate switch 516 in the off state to prevent the positive stepped-up voltage from being applied to node 530 and corresponding signals 586, 594 may be configured to operate switch 520 in the on state to apply the negative stepped-up voltage to node 530. In this example, switches 524 and 528 are continuously maintained in the off state. It will be appreciated that the positive and negative voltages producing an AC output may also be applied to node 532 by selective operation of switches 524, 528 while continuously maintaining switches 516 and 520 in the off state.

In some embodiments, in addition to the control of the operating states of the switches by the control signals, differential drivers 548, 552 may not be able to be operated concurrently in an on state. This may result in a short time delay when the operating state of complementary pairs of switches 516, 520 and 524, 528 are transitioning between opposite operating states. For example, control signal 584 may be configured to change switch 516 from an off state to an on state at the end of duration T4 when control signal 586 is configured to change switch 520 from an on state to an off state. The result is a short duration, represented by time duration T5, when switches 516, 520 are off. This transition period during which both complementary switches are in a non-conducting (off) state may provide a further increased level of safety (e.g., by ensuring that both of voltages 572, 576 are not applied to the same node at the same time).

FIG. 4 similarly depicts a schematic timeline of exemplary voltage levels on nodes 530, 532 in similar consecutive time durations T1′-T7′, but when producing the second AC voltage resulting from the concurrent application of opposite voltages to the two output nodes. Generally, when a positive voltage is applied to one node a negative voltage is applied to the other node, with the voltages at each node alternating as shown to produce an AC voltage having a frequency determined by control circuit 508.

Specifically, the alternating voltage level on node 530, as described above with reference to FIG. 3, is shown in the upper portion of FIG. 4 for corresponding durations T1′-T7′. An oppositely alternating voltage level on node 532 is shown in a lower portion of FIG. 4. As can be seen and/or inferred, switches 524, 528 in combination with switches 516, 520 may be operated by controller circuit 508 to produce the second AC voltage output. During durations T2′ and T6′, the positive stepped-up voltage is applied to node 530 by switch 516 and the negative stepped-up voltage is applied to node 532 by switch 528. During duration T4′, the negative stepped-up voltage is applied to node 530 by switch 520 and the positive stepped-up voltage is applied to node 532 by switch 524.

During durations T2′, T6′, corresponding signals 588, 596 may be configured to operate switch 524 in the off state to prevent the positive stepped-up voltage from being applied to node 532. During duration T4′, corresponding signals 590, 598 may be configured to operate switch 528 in the off state and corresponding signals 588, 596 may be configured to operate switch 524 in the on state to apply the positive stepped-up voltage to node 532. Concurrently, corresponding signals 590, 598 may be configured to operate switch 528 in the off state to prevent the negative stepped-up voltage from being applied to node 532.

During durations T1′, T3′, T5′, T7′, respectively corresponding signals 588, 596 and 590, 598 may be configured to respectively operate switches 524, 528 in the off state to prevent either of the positive or negative stepped-up voltages from being applied to node 532, which in conjunction with the concurrent off state of switches 516, 520 as produced by the control signals from controller circuit 508 and/or the time delay of driver 548, may result in the second AC voltage also better approximating a sinusoidal waveform than if these quiescent periods did not exist

While the positive and negative stepped-up voltages are respectively shown in FIG. 4 to be +120V and −120V, in other embodiments these stepped-up voltages may be different. For example, if they are +60V and −60V, the operation of switches 516, 520, 524, 528, as indicated in FIG. 4, may be used to produce the first AC 120-volt output.

Referring back to FIG. 2, controller circuit 508 may be configured to receive an input from an operator selecting either the first AC voltage output or the second AC voltage output. Controller circuit 508 may be configured to send a control signal (e.g., one or more of signals 584, 586, 588, 590) to driver assembly 534 appropriate to control operation of switches 516, 520, 524, 528 to produce the selected AC voltage. For example, a first operator input may select the first AC voltage (e.g., 120 VAC), and in response to (or based on, or in accordance with) the first operator input, controller circuit 508 may produce control signals 584, 586, 588, and/or 590 to alternatingly output the positive and negative stepped-up voltages on node 530 but not on node 532 (e.g., as depicted in FIG. 3).

In response to a second operator input selecting the second AC voltage (e.g., 240 VAC), controller circuit 508 may produce control signals 584, 586, 588, 590 to alternatingly output the positive and negative stepped-up voltages on node 530, and alternatingly output the opposite positive and negative stepped-up voltages on node 532, in a manner similar to that shown in FIG. 4.

In some embodiments, in response to the first operator input, the controller circuit 508 may be configured to produce potentiometer control signal 560 appropriate for causing the boost converter to produce positive and negative stepped-up voltages of +60V and −60V. In this case, the switch control signals 584, 586, 588, 590 may be generated by controller circuit 508 to control switches 516, 520, 524, 528 to produce 120 VAC as in a manner similar to that shown in FIG. 4.

In some embodiments, in response to the second operator input, the controller circuit 508 may be configured to produce potentiometer control signal 560 appropriate for causing the boost converter to produce positive and negative stepped-up voltages of +240V and −240V. In this case, the switch control signals 584, 586, 588, 590 generated by controller circuit 508 to control switches 516, 520, 524, 528 may produce 240 VAC in a manner similar to that shown in FIG. 3.

The above description is intended to be illustrative and not restrictive. Many other embodiments will be apparent to those skilled in the art, upon reviewing the above description. The scope of the inventions should therefore be determined with reference to the appended claims, along with the full scope of equivalents to which such claims are entitled. This disclosure may include one or more independent or interdependent inventions directed to various combinations of features, functions, elements and/or properties, one or more of which may be defined in the following claims. Other combinations and sub-combinations of features, functions, elements and/or properties may be claimed later in this or a related application. Such variations, whether they are directed to different combinations or directed to the same combinations, whether different, broader, narrower or equal in scope, are also regarded as included within the subject matter of the present disclosure.

An appreciation of the availability or significance of claims not presently claimed may not be presently realized. Accordingly, the foregoing embodiments are illustrative, and no single feature or element, or combination thereof, is essential to all possible combinations that may be claimed in this or a later application. Each claim defines an invention disclosed in the foregoing disclosure, but any one claim does not necessarily encompass all features or combinations that may be claimed. Where the claims recite “a” or “a first” element or the equivalent thereof, such claims include one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated. Ordinal indicators may be applied to associated elements in the order in which they are introduced in a given context, and the ordinal indicators for such elements may be different in different contexts.

What is claimed is:

1. An apparatus comprising:
an data management assembly including a data input, a data output, and a power port, the data management assembly being configured to receive in combination a data signal and a variable DC input voltage on the data input, separate the received data signal from the input voltage, output the data signal on the data output, and output the input voltage on the power port; and
a DC to AC inverter assembly configured to receive the input voltage from the power port, boost the input voltage to a predetermined DC stepped-up voltage that is constant for different input voltages, convert the stepped-up voltage to an AC voltage, and output the AC voltage on a power output.

2. The apparatus of claim 1, wherein the DC to AC inverter assembly includes a boost converter and a controller circuit, the boost converter being configured to step the input voltage up to a stepped-up voltage determined by a voltage-control signal, and the controller circuit being responsive to an input-voltage signal representative of the input voltage to produce the voltage-control signal appropriate to cause the boost converter to step up the input voltage to the predetermined DC stepped-up voltage.

3. The apparatus of claim 2, wherein the boost converter includes a potentiometer for producing a resistance based on the voltage-control signal, and a booster circuit connected to the potentiometer for stepping up the input voltage based on the produced resistance.

4. The apparatus of claim 2, wherein the DC to AC inverter assembly includes an inductor assembly, a first switch, and a second switch; the inductor assembly being configured to receive the predetermined DC stepped-up voltage from the boost converter and to produce therefrom positive and negative stepped-up voltages, the first and second switches being configured to receive a respective one of the positive and negative stepped-up voltages, the controller circuit being configured to operate the first and second switches to alternatingly output the positive and negative stepped-up voltages to produce a first AC voltage on the power output.

5. The apparatus of claim 4, wherein the controller circuit is configured to operate both the first and second switches in an off state prior to operating either one of the switches in an on state.

6. The apparatus of claim 5, wherein the DC to AC inverter assembly includes a switch driver assembly, an opto-coupler electrically connected between the controller circuit and the switch driver assembly, the controller circuit being configured to operate both the first and second switches via the opto-coupler and the switch driver assembly, the opto-coupler being configured to communicate a switch control signal from the controller circuit to the driver assembly and to electrically isolate the controller circuit from the driver assembly.

7. The apparatus of claim 5, wherein the DC to AC inverter assembly includes third and fourth switches operatively coupled to the switch driver assembly for controlling by the controller circuit, the first and second switches selectively applying a first output voltage to a first node connected to the power output, and the third and fourth switches selectively applying a second output voltage to a second node connected to the power output, the third and fourth switches being configured to receive a respective one of the positive and negative stepped-up voltages, the controller circuit being configured to operate the third and fourth switches in combination with the first and second switches to produce a second AC voltage by alternatingly outputting (1) a combination of the positive stepped-up voltage on the first node and the negative stepped-up voltage on the second node, and (2) a combination of the negative stepped-up voltage on the first node and the positive stepped-up voltage on the second node.

8. The apparatus of claim 7, wherein the controller circuit is configured to receive an input from an operator selecting either the first AC voltage or the second AC voltage, the controller circuit being configured to send a control signal to the driver assembly appropriate to control operation of the first, second, third, and fourth switches to produce the selected AC voltage.

9. An apparatus comprising:
a data management assembly including a data input, a data output, and a power port, the management assembly being configured to receive in combination a data signal and a variable DC input voltage on the data input, and to separate the data signal and the input voltage, output the data signal on the data output, and output the separated input voltage on the power port;
a boost converter configured to receive the input voltage on the power port, and to boost the input voltage to a DC stepped-up voltage determined by a voltage-control signal;
a controller circuit configured to receive an input-voltage signal representative of the received input voltage, and to generate the voltage-control signal appropriate to cause the boost converter to boost the input voltage to a predetermined stepped-up voltage that is constant for different input voltages;
an inductor assembly configured to receive the predetermined stepped-up voltage from the boost converter, and to produce therefrom positive and negative stepped-up voltages;
first and second switches configured to apply the respective positive and negative stepped-up voltages from the inductor assembly to a first output node, in response to received switch drive signals;
a driver assembly electrically connected to the first and second switches for producing the switch drive signals in response to received switch control signals; and
an opto-coupler for conveying switch control signals output by the controller circuit to the driver assembly and being configured to electrically isolate the controller circuit from the driver assembly;
wherein the controller circuit is configured to generate switch control signals to operate the first and second switches via the opto-coupler and the driver assembly to alternatingly apply the positive and negative stepped-up voltages to the first output node to produce an AC voltage output between the first output node and a second output node.

10. The apparatus of claim 9, wherein the positive stepped-up voltage is within 10 percent of +120 VDC and the negative stepped-up voltage is within 10 percent of −120 VDC.

11. The apparatus of claim 9, wherein the driver assembly includes first and second differential drivers, the apparatus further comprising third and fourth switches having outputs connected to the second output node, the third and fourth switches being configured to receive the respective positive and negative stepped-up voltages from the inductor assembly, the controller circuit being configured to operate the first and second switches via the opto-coupler and the first differential driver and the third and fourth switches via the opto-coupler and the second differential driver to produce the AC voltage output by alternatingly outputting (1) a combination of the positive stepped-up voltage on the first output node and the negative stepped-up voltage on the second output node, and (2) a combination of the negative stepped-up voltage on the first output node and the positive stepped-up voltage on the second output node.

12. The apparatus of claim 11, wherein the first, second, third, and fourth switches are respective first, second, third, and fourth field-effect transistors.
